(19) United States
(12) Patent Application Publication
(10) Pub. No.: US 2007/0045339 A1
(43) Pub. Date: Mar. 1, 2007

(54) Beverage dispensing box for office and kitchen counters

(76) Inventor: Randolph Thomas Manion, Golden, CO (US)

Correspondence Address: Randolph Thomas Manion, P.O. Box 673, Golden, CO, 80402, US

(21) Appl. No.: 11/286,477

(22) Filed: Nov. 26, 2005

Related U.S. Application Data
(60) Provisional application No. 60/711,482, filed on Aug. 27, 2005.

(51) Int. Cl. B65D 35/28; B67D 5/06; B67D 5/42

(52) U.S. Cl. 222/95; 222/386.5; 222/185.1

(57) ABSTRACT

The Beverage Dispensing Box for Office and Kitchen Counters is intended to hold a flexible disposable beverage bag filled with a potable liquid and dispense that liquid under pressure when the spigot is opened. The Beverage Dispensing Box is unique in that it employs the law of gravity. Through the use of a sloped container floor and a weighted pressure plate, a natural force (non-mechanical or electrical) is applied to the flexible disposable beverage bag, thus causing the potable liquid to flow from the bag under pressure at a greater gallon per minute (GPM) rate than that of a typical un-pressurized flexible disposable beverage bag—commonly found in corrugated cardboard boxes such as the Wine-in-a-Box container; and at a greater GPM rate than that of a typical 2.5 or 5 gallon bottled water dispensing apparatus. The Beverage Dispensing Box is designed to sit on office, kitchen or other countertops where no electricity is required for use. The Beverage Dispensing Box is a durable reusable container that will positively impact the environment because it will be manufactured from recycled plastic and metals; and will displace the need for disposable plastic bottles, such as bottled water.

### CROSS-REFERENCE TO RELATED APPLICATIONS

This application claims the benefit of provisional patent application Ser. No. 60/711,482, filed 2005 Aug. 27, by the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to the category of potable water dispensers and beverage dispensers such as coffee, tea, and juice. It is also in the field of packaging and distributing potable bottled water for home and office consumption. Current U.S. Class: 222/105;

2. Prior Art

In the United States, flexible disposable beverage bags have traditionally been used by the wine industry, packaged in corrugated cardboard boxes. In Australia and South America, flexible disposable beverage bags have been used for potable water, but these were also packaged in disposable corrugated cardboard boxes.

Cost is the primary reason flexible disposable beverage bags have not been used outside the wine industry in the United States. Using a disposable corrugated cardboard box as the container for a flexible disposable beverage bag adds $0.55 for each five liters of potable water. In the bottled water industry, this is a huge added cost and totally unacceptable.

Furthermore, placing a flexible doable beverage bag in a typical corrugated cardboard box, such as the Wine-in-a-Box trademarked product, makes for an in-efficient way to disperse liquid. When you open the fitment spigot on a Wine-in-a-Box product, the liquid comes out slowly—when compared to the rate of flow from a 5 gallon bottled water dispenser. People are busy and the bottled water industry recognized early on that packaging potable water in a flexible disposable beverage bag in a traditional corrugated cardboard a would be unacceptable to most consumers. Furthermore, when the liquid inside the flexible disposable beverage bag nears its depletion, it requires tipping the cardboard container at a steep angle while holding the fitment spigot open to get all the liquid from the bag in the box. More often than not, liquid is wasted and remains in the bag because the consumer does not want to wait while the liquid slowly drips out.

There have been devises such as U.S. Pat. No. 6,926,170 to Groesbeck (Aug. 9, 2005), which uses a complex electrical and mechanical system to pump water from the flexible disposable beverage bag supported by a corrugated cardboard box to a drink dispensing machine. This addresses the in-efficient water flow problem associated with the Wine-in-a-Box dispensing method. However, new complications arise by the required use of electricity to power a mechanical device in order pump the liquid from the bag to the drink dispensing machine.

The disadvantages associated with marketing potable water in flexible disposable beverage bags packaged in corrugated cardboard boxes have outweighed the advantages so the bottled water industry has never (or very infrequently) pursued this method of marketing their products to date.

Since 1996 I have been evaluating how to enter and compete in the bottled water industry. At first I seriously considered packaging my trademarked products using flexible disposable beverage bags in disposable corrugated cardboard boxes. However, given the above stated disadvantages, I reached the same conclusions as the bottled water industry and determined not to use this method of selling water.

With annual growth rates at 19 percent since 1993 (6.3 billion gallons of bottled water were consumed in the United States in 2003), one would think anyone could compete in this fast growing industry. Not so, the bottled water industry is extremely competitive and you need a unique, high quality, product in order to be successful and profitable.

Of the 6.3 billion gallons consumed in the U.S. in 2003, almost 100% were met with water packaged in plastic bottles. In the past decade, there has been a significant shift towards plastic as a substitute for glass in the manufacturing of bottled water containers. Between 1995 and 2001, there was a 56 percent increase in the production of plastic resins in the United States—from 32 million tons to over 50 million tons annually. According to the U.S. Environmental Protection Agency, plastics are the fastest growing form of municipal solid waste in the country. These plastic bottles pose four problems: 1) Fossil fuels and toxic chemical pollution caused in the manufacturing process of these bottles; 2) Chemicals like phthalates, which are used to soften the hard plastics used in home and office delivered water bottles, are known to leach into the water over time, potentially contaminating the water in these bottles; 3) An out of control waste stream from disposable plastic bottles in the United States—with no end in sight—the bottled water industry is reluctant to embrace, adopt or support recycling regulations and legislation; and 4) Traditional 2.5 and 5 gallon bottled water containers that are “re-used” pose the risk of contamination during the washing process.

### OBJECTS AND ADVANTAGES

Given the above stated issues and concerns with plastic bottles and five liter corrugated cardboard box containers, I invented the Beverage Dispensing Box for Office and Kitchen Counters as a way to differentiate my Purely Oregon, Naturally Oregon and Water-in-a-Box trademarked spring and drinking water brands from the competition. This invention aims to address each of the above stated issues by: 1) reducing the need for plastic bottles in home and office water consumption; 2) increasing the purity of the water by reducing the risk of contamination caused in the “re-use” washing process of 2.5 and 5 gallon bottles; 3) manufacturing the Beverage Dispensing Box for Office and Kitchen Counters from recycled HDPE plastic bottles and other recycled plastics; 4) providing a more convenient sized home and office beverage container (five liter flexible disposable beverage bag) which is easier to move, lift and store than the traditional 2.5 and 5 gallon bottled water containers used today; 6) eliminating the need of a five liter disposable corrugated cardboard box support container when using flexible disposable beverage bags; 7) increasing the liquid flow rate by 75% from the flexible disposable beverage bag fitment spigot (compared to the typical flow rate from a Wine-in-a-Box fitment spigot); and increasing the liquid flow rate by 40% from the flexible disposable beverage bag fitment spigot (compared to the typical flow rate from a 2.5 or 5 gallon plastic bottle spigot)—this is accomplished by pressurizing the flexible disposable beverage bag with a weighted pressure plate (a non-electrical mechanical devise) thus allowing the Beverage Dispensing Box for Office and Kitchen Counters to be used reliably, safely, efficiently, anywhere, and without fear of mechanical breakdown, electrical malfunction or the need for electricity for operation; and 8) ensuring every last drop of liquid is dispensed from the flexible disposable beverage bag in an efficient manner using a 10 degree sloped floor in combination with an offset weighted pressure plate, four pounds toward the back of the plate and three pounds toward the front, thus causing the liquid at the back of the bag to be pressured out of the bag first.

### SUMMARY

A first time home or office customer will typically order and purchase one Beverage Dispensing Box for Office and Kitchen Counters. In addition, the customer will order and purchase at least one shipment of five (5) liter disposable flexible bags of potable spring water (the Beverage Dispensing Box for Office and Kitchen Counters will typically use a five liter flexible disposable beverage bag but the invention can be manufactured to accept all sizes of bags).

The customer, once in receipt of the invention and disposable flexible bags of potable spring water or other potable liquid, will place one of the (5) liter bags into the Beverage Dispensing Box for Office and Kitchen Counters. Generally, the customer will use this devise for their drinking water needs in place of tap water (could be used for other hot and cold beverages such as tea and soft drinks); and will displace any bottled water typically used in 2.5 and 5 gallon plastic containers; and in some cases, will replace smaller more flexible plastic disposable bottles known at PET.

The Beverage Dispensing Box for Office and Kitchen Counters can be placed on an office desk or office counter; kitchen counter, garage workshop counter, just about anywhere because no electricity is required. The Beverage Dispensing Box for Office and Kitchen Counters invention includes twenty-six designed parts plus two parts associated with the flexible disposable beverage bag. These parts enable one five (5) liter disposable flexible beverage bag of potable liquid to be placed into the Beverage Dispensing Box for Office and Kitchen Counters. The Beverage Dispensing Box is designed with a 10-degree sloped container floor and a weighted pressure plate that applies a natural force (non-mechanical) to the flexible disposable beverage bag, which enables the liquid to flow from the bag at rate 75% greater, for each gallon per minute, than that of a typical un-pressurized flexible disposable beverage bag; and at rate 40% greater, for each gallon per minute, than that of a typical 2.5 and 5 gallon plastic bottle. The combination of gravity caused by the 10-degree sloped container floor and a 7-pound lead weighted pressure plate work together to create 7-foot pounds of natural pressure that forces the liquid from the fitment spigot when the spigot is opened. The Beverage Dispensing Box for Office and Kitchen Counters is unique in that no pumps, controls, sensors, circuits, or other electrical or mechanical powered devices are required to pressurize the potable liquid in the flexible disposable beverage bag; furthermore, the invention dispenses 100% of the liquid quickly, efficiently, completely and effortlessly.

The Beverage Dispensing Box for Office and Kitchen Counters is designed to sit on office, kitchen or any other countertop—and no electricity is required to use the invention. The Beverage Dispensing Box is a durable and reusable container manufactured out of recycled plastic and recycled lead (the lead is used to make the weighted pressure plate). The Beverage Dispensing Box for Office and Kitchen Counters can be manufactured for any size of flexible disposable beverage bags and can be reused thousands of times, year-after-year.

It's important to note that the sale, marketing, and distribution of this invention will be similar to the techniques used today in home and office delivery of bottled water. Although, home and office consumers will be the primary target group for my invention, it is possible that the Beverage Dispensing Box for Office and Kitchen Counters could be sold in retail stores as well.

### DRAWINGS—FIGURES

The following drawings show how the invention is designed. In the drawings, closely related figures have the same number but different alphabetic suffixes:

FIG. 1 is a right side perspective with an inside view of the Beverage Dispensing Box for Office and Kitchen Counters. It shows the removable front panel and the non-removable front panel; the lid “cover” retention lip (which holds the removable front panel in place) the circular hole where the five-liter flexible disposable beverage bag fitment spigot is placed; and the 10 degree sloped floor.

FIG. 2 is a right side perspective with an inside view of the Beverage Dispensing Box for Office and Kitchen Counters showing the weighted pressure plate on the top of a flexible disposable beverage bag.

FIG. 3 is an underside perspective of the Beverage Dispensing Box showing a total of five, three-quarter inch diameter rubber feet, with screws holding the rubber feet in place.

FIG. 4 is an overhead perspective of the Beverage Dispensing Box—without the lid “cover.” The perspective also shows the right and left side lid “cover” retention holes in which the lid “cover” retention pegs slide into. This allows the lid “cover” to hold securely in place the left and right side walls of the beverage box while the weighted pressure plate exerts pressure on the flexible disposable beverage bag. It also shows the top of the removable front panel.

FIG. 5 is an overhead view of the weighted pressure plate.

FIG. 5.1 is a left side view of the pressure plate.

FIG. 5.2 is a front view of the pressure plate.

FIG. 6 is an underside view of the lid “cover” to the Beverage Dispensing Box. This perspective allows a view of the left and right side lid “cover” retention pegs and the lid “cover” retention lip.

FIG. 6.1 is a left side perspective of the lid “cover.” This perspective allows a view of the left side lid “cover” retention peg, the quarter inch lid offset, which allows the lid to fit secure on the walls of the container, and a left side view of the lid “cover” lip which holds the removable front panel in place.

FIG. 6.2 is a right side perspective of the lid “cover.” This perspective allows a view of the right side lid “cover” retention peg, the quarter inch lid offset, which allows the lid to fit secure on the walls of the container, and a right side view of the lid “cover” lip which holds the removable front panel in place.

FIG. 7 right side view of the Beverage Dispensing Box assembled without the flexible disposable beverage bag.

FIG. 8 is a front view of the Beverage Dispensing Box.

FIG. 9 is a left side view of the Beverage Dispensing Box, also showing three of the five rubber feet that are attached to the bottom of the box.

FIG. 10 is a right side view of the flexible disposable beverage bag with its fitment spigot.

### REFERENCE NUMERALS

1 Right container wall
2 Left container wall
3 Removable front container panel
4 Circular opening for fitment spigot
5 Non-removable front container wall
6 Rear container wall
7 Bottom of container
8.a Rubber foot
8.b Rubber foot
8.c Rubber foot
8.d Rubber foot
8.e Rubber foot
9 Right panel retention hole
10 Left panel retention hole
11 Left side lid “cover” retention peg
12 Right side lid “cover” retention peg
13 Container lid “cover”
14 Lid “cover” retention lip
15 Lid “cover” retention insert
16 Right side weighted pressure plate
17 Top side weighted pressure plate
18 Front side weighted pressure plate
19 Weighted pressure plate grab handle
20 Four pound lead weight
21 Three pound lead weight
22 Ten degree sloped container floor
23 Flexible disposable beverage bag
24 Fitment spigot
25.a Rubber foot retention screw
25.b Rubber foot retention screw
25.c Rubber foot retention screw
25.d Rubber foot retention screw
26 Back side weighted pressure plate
27 Left side weighted pressure plate
28 Bottom side weighted pressure plate

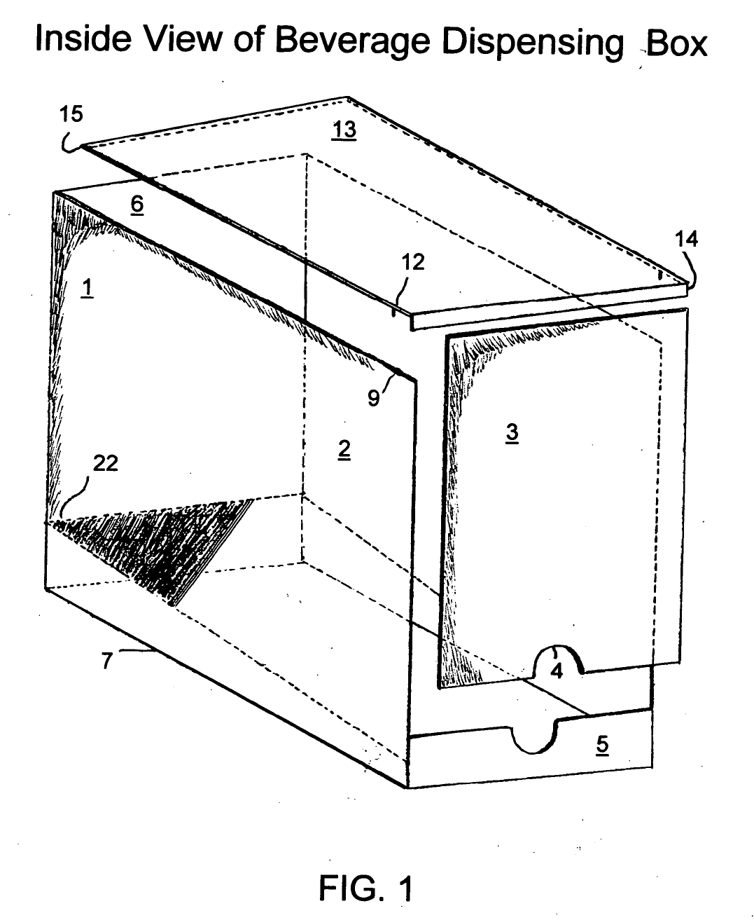

### DETAILED DESCRIPTION—FIGS. 1, 2, 3, 4, 6—PREFERRED EMBODIMENT

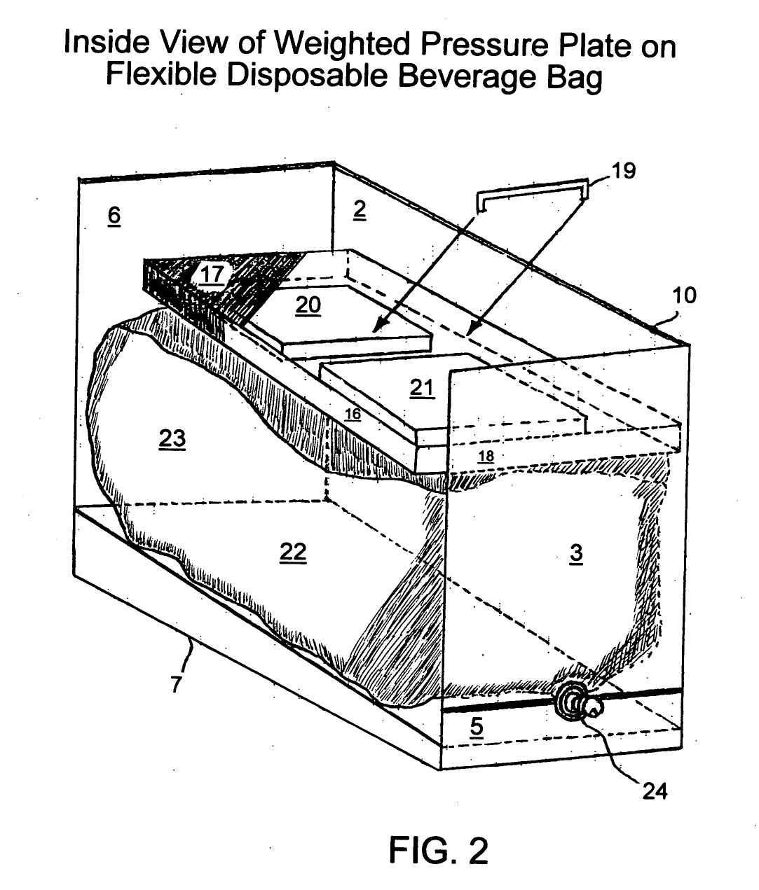

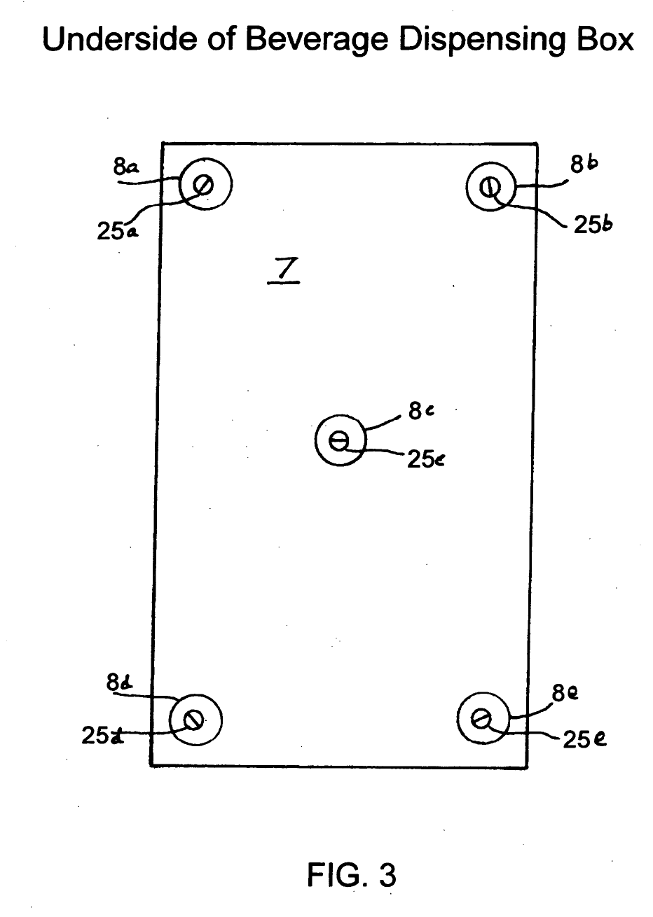

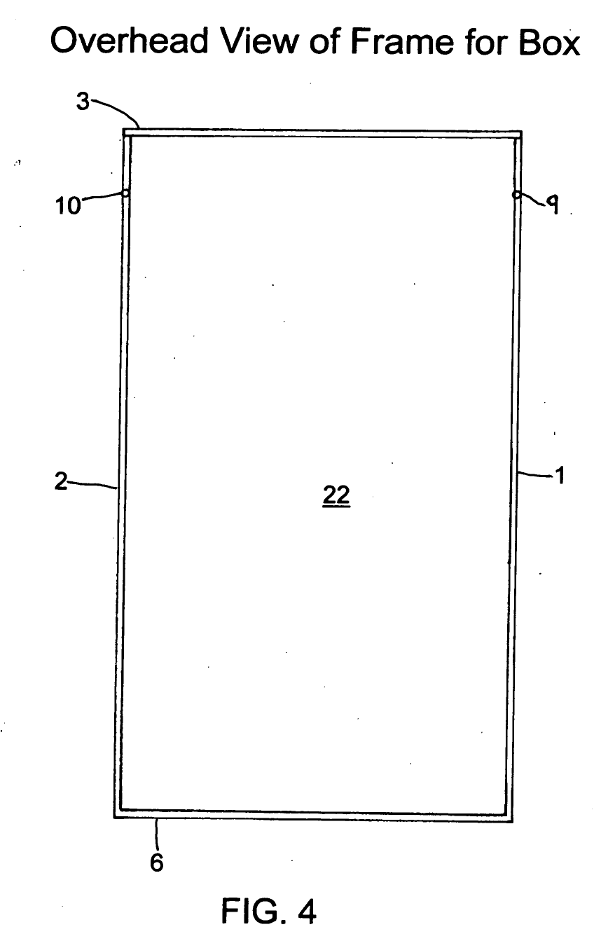

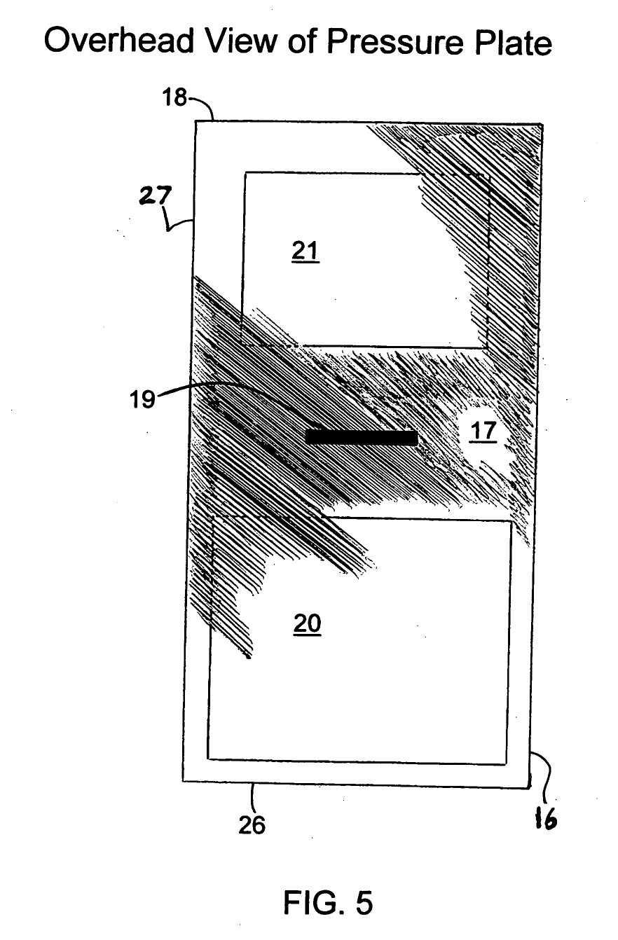

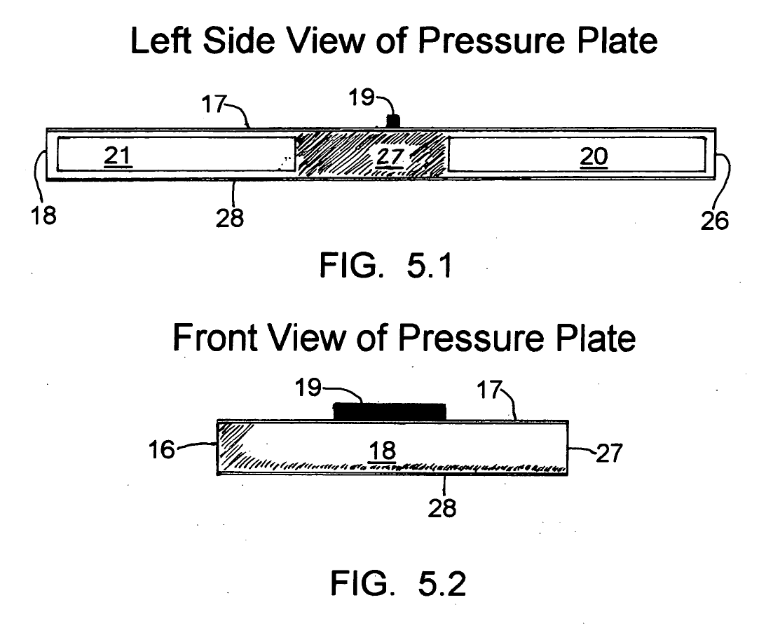

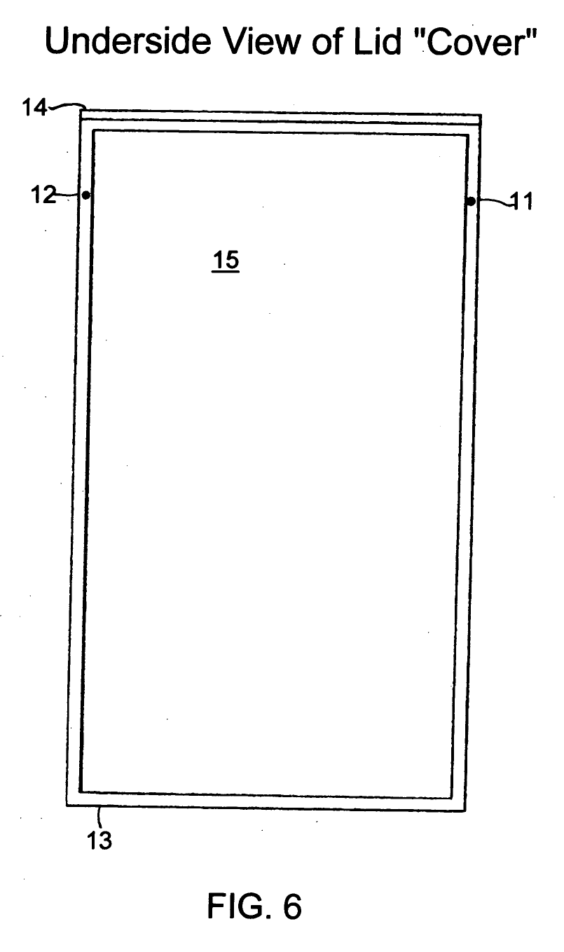

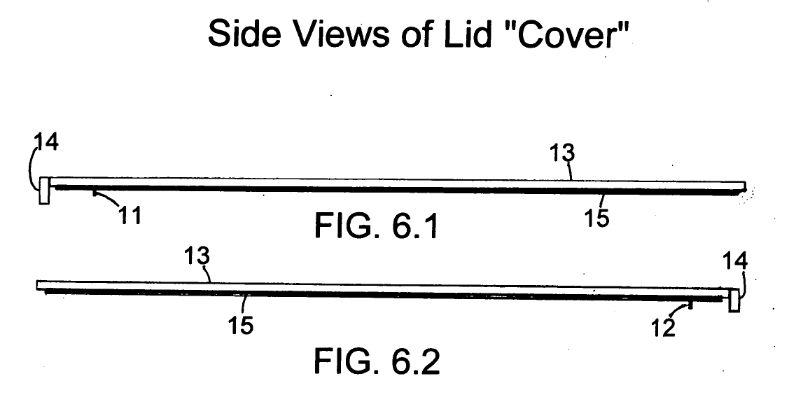

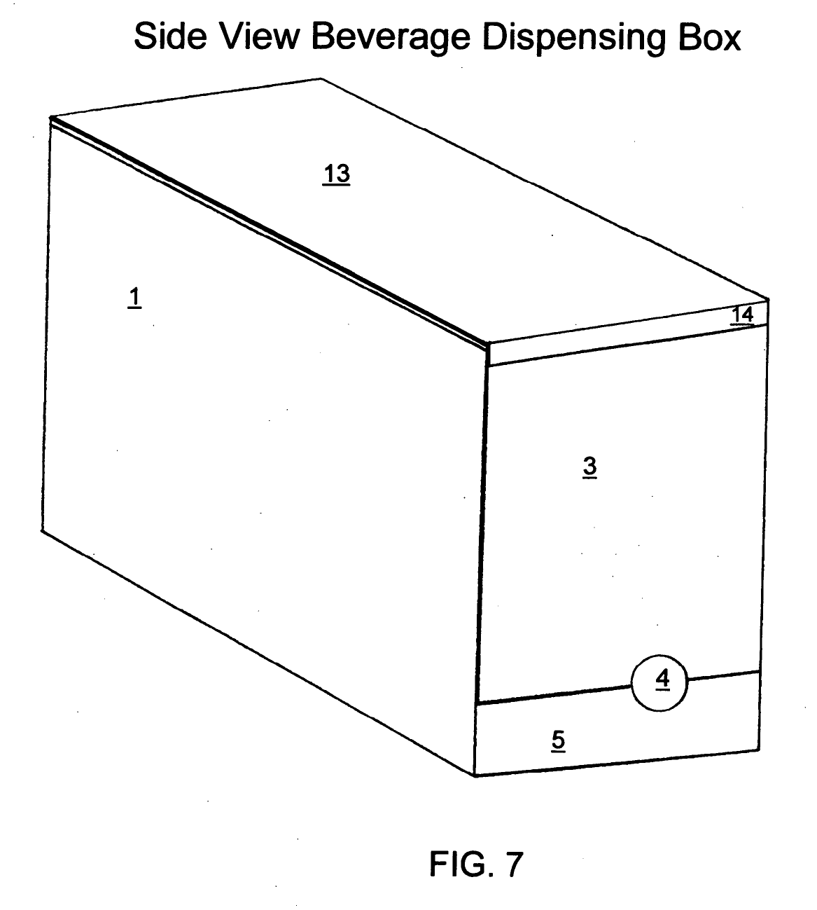

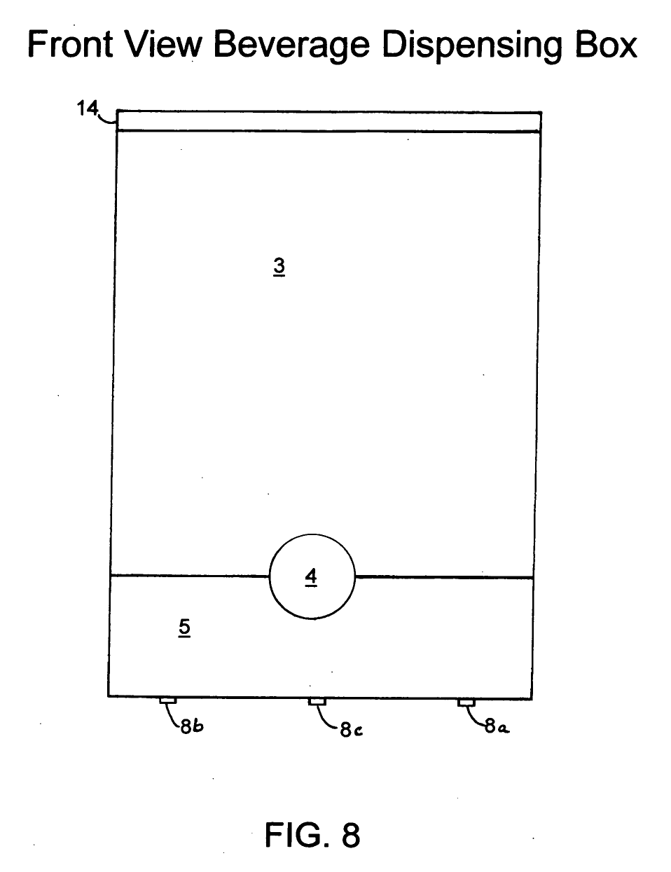

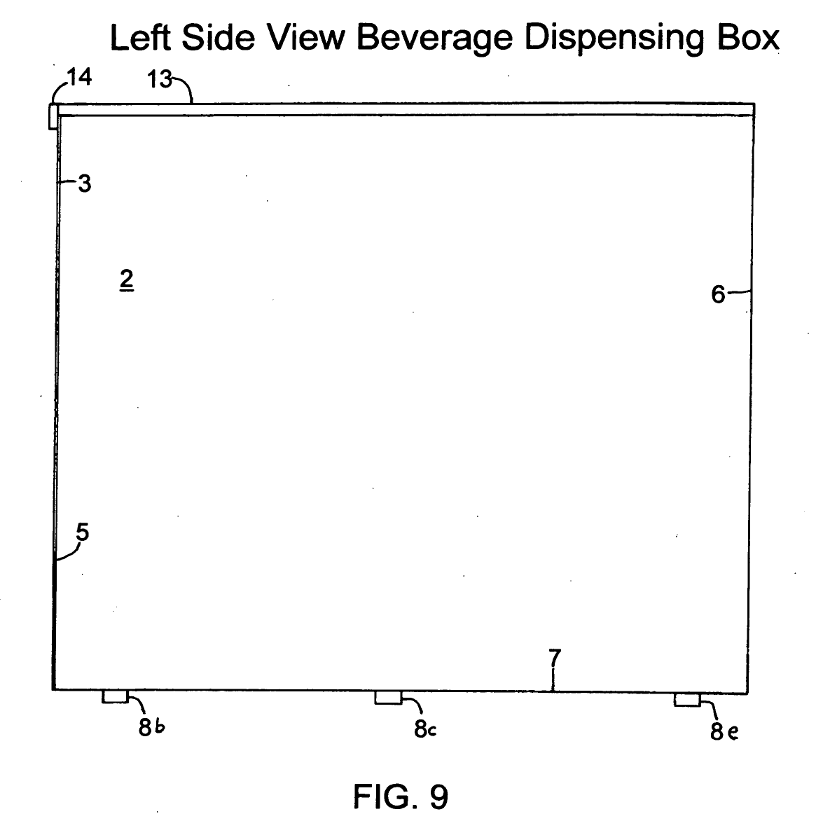

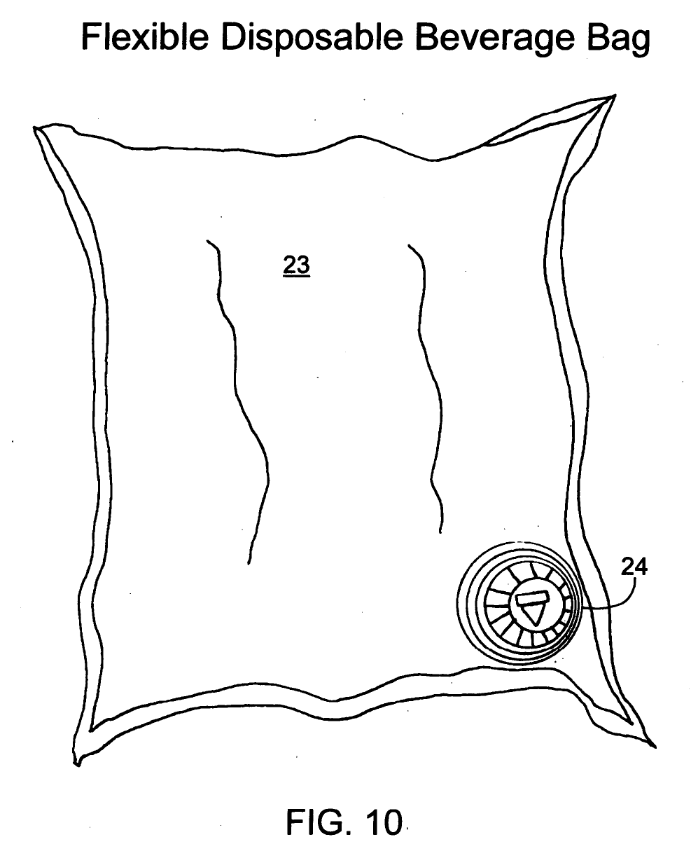

A preferred embodiment of the Beverage Dispensing Box for Office and Kitchen Counters invention is illustrated in FIG. 1 (inside view with parts lifted), FIG. 2 (inside view with weighted pressure plate on flexible disposable beverage bag), FIG. 3 (underside view of container), FIG. 4 (overhead view of container frame), and FIG. 6 (underside view of lid “cover”). The invention sits on five rubber feet 8 that are attached with screws 25 which are mounted on the underside of the Beverage Dispensing Box container 7. The Beverage Dispensing Box can be made from various plasticized materials, various fibrous materials, among other durable and sturdy materials.

A flexible disposable beverage bag 23, made from a copolymer material (which does not leach a plastic or other flavor to the beverage in the bag), is placed into the Beverage Dispensing Box for Office and Kitchen Counters onto a sloped floor 22 so the liquid inside the flexible disposable beverage bag flows toward the lower non-removable front panel 5. Once the flexible disposable beverage bag is placed into the Beverage Dispensing Box and the fitment spigot 24 is fit securely into the lower non-removable front panel 5 with the groves of the fitment spigot inserted into the half circle opening 4. The removable front panel 3 is then installed with the half circle 4 inserted between the grooves of the fitment spigot 24. Next, the weighted pressure plate 16, 17, 18, 19, 20, 21, 26 and 27 is placed on the flexible disposable beverage bag 23 with the heavier end of the weighted pressure plate 20 toward the back of the container 6 causing slightly more pressure on the rear of the bag. The purpose for the slightly heavier weight 20 toward the back of the weighted pressure plate than towards the front 21 is to ensure the liquid in the flexible disposable beverage bag gets pushed towards the front of the bag first when near total depletion. The weight 20 and 21 in the weighted pressure plate can be constructed from lead, steel or other material with significant mass. The weighted pressure plate 16, 17, 18, 19, 26 and 27 can be made from various plasticized materials, various fibrous materials, among other durable and sturdy materials.

The lid “cover” 13 is placed on the top of the right container wall 1, the left container wall 2, the rear container wall 6 and the removable front panel 3. When installing the lid “cover” 13 the right retention peg 12 and the left retention peg 11, both located toward the front of the lid on each side of the lid “cover” retention insert 15, will be inserted in the right retention peg hole 9 and the left retention peg hole 10, located on the top of the left container wall 2 and right container wall 1, to keep the container walls from pushing out from the pressure of the flexible disposable beverage bag 23 with the weighted pressure plate 16, 17, 18, 19, 20, 21, 26 and 27 in place. Furthermore, the lid “cover” 13 retention lip 14 is fit over the top of the removable front panel 3, to hold the front panel in place.

At this time, the manufacturing and assembly of the Beverage Dispensing Box for Office and Kitchen Counters invention will include twenty-six designed parts plus two design parts associated with the flexible disposable beverage bag. However, future mass-production of the Beverage Dispensing Box for Office and Kitchen Counters could be reduced to only 7 design parts through plastic or other molds. These parts would include: I) the base of the container 1, 2, 4, 5, 6, 7, 9, 10 and 22; II) the lid “cover” 11, 12, 13, 14, and 15; III) the removable front panel 3 and 4; IV) five rubber feet 8a, 8b, 8c, 8d, and 8e; and five retention screws 25a, 25b, 25c, 25d, and 25e; V) weighted pressure plate cover 16, 17, 18, 19, 26 and 27; VI) heavy weight 20; VII) slightly lighter weight 21.

While a single embodiment of the Beverage Dispensing Box for Office and Kitchen Counters has been shown, it should be realized that various designs of the Beverage Dispensing Box can be used and that the designs of the Beverage Dispensing Box from an appearance standpoint are not functional aspects of the invention. Also, the Beverage Dispensing Box for Office and Kitchen Counters could be made with various dimensions and may be sized to larger or smaller flexible disposable beverage bags.

Advantages

Once the Beverage Dispensing Box for Office and Kitchen Counters is assembled with the flexible disposable beverage bag and weighted pressure plate in place, the invention is moved to the edge of an office, kitchen or other type of counter top for operation. By pressing on the fitment spigot valve 24, the potable liquid exits the flexible disposable beverage bag with a minimum of seven foot-pounds of pressure. This results in the liquid exiting from the Beverage Dispensing Box for Office and Kitchen Counters invention at a rate 75% greater than that of traditional flexible disposable beverage bags used in the Wine-in-a-Box or other similar non-electrical mechanical containers; and, increasing the liquid flow rate by 40% when compared to the typical flow rate from a 2.5 or 5 gallon plastic bottle spigot typically used in office and homes in the bottled water industry. By pressurizing the flexible disposable beverage bag with a weighted pressure plate (a non-electrical mechanical devise) the Beverage Dispensing Box for Office and Kitchen Counters can be used reliably, safely, efficiently, anywhere, and without fear of electrical shock or mechanical breakdown, electrical malfunction, and the need for electricity for operation.

The invention ensures every last drop of liquid is dispensed from the flexible disposable beverage bag in an efficient manner using a minimum 10 degree sloped floor 22 in combination with an offset weighted pressure plate 16, 17, 18, 19, 20, 21, 26 and 27, a minimum of four pounds toward the back of the plate 20 and three pounds toward the front 21, thus causing the liquid at the back of the bag to be pressured out of the bag first. Furthermore, the Beverage Dispensing Box for Office and Kitchen Counters invention ensures every last drop of liquid exits the flexible disposable beverage bag in an efficient and timely manner.

In addition to the stated advantages of using the Beverage Dispensing Box for Office and Kitchen Counters invention, the invention will allow new methods of marketing beverages and in particular, potable water, to displace the use of traditional plastic disposable and reusable bottles. Franchise distributors, for example, could disperse the invention and the flexible disposable beverage bags to multiple States and countries from one central packaging and warehousing location. Traditional bottled water companies are committed to a confined distribution area, usually within a 75-mile radius or less from the beverage bottling facility.

If distribution of this product is coordinated through franchise distributors, only those purchasing a franchise can market the Beverage Dispensing Box for Office and Kitchen Counters invention and associated flexible disposable beverage bags which hold the trademark “Purely Oregon,” “Naturally Oregon” and Water-in-a-Box spring water and potable water brands. Traditional bottled water marketing channels may be considered at a later date, such as grocery stores, grocery distributors; and discount, membership, and other retail stores.

Another unique feature associated with the Beverage Dispensing Box for Office and Kitchen Counters is the way the flexible disposable beverage bags are packaged for shipping. The corrugated cardboard box used for shipping will be designed 30 inches high, 10 inches wide and 5 inches in breadth. The corrugated cardboard shipping box will include a plastic handle at the tall end of the corrugated cardboard box for easy handling. Traditional corrugated cardboard shipping boxes are 20 inches long, 13 inches high×12 inches wide. Placing five, 5-liter bags (6.6 gallons) into a traditional corrugated shipping box can be extremely heavy and difficult to pickup and move. With the newly designed corrugated cardboard shipping box, almost anyone pick up the box because of its height and plastic handle.

Furthermore, corrugated cardboard shipping boxes can be stacked more effectively on a standard shipping pallet than traditional 2.5 and 5 gallon plastic bottles. This results in more gallons of potable water or other beverage packaged on each standard shipping pallet; and more pallets on each standard 40 foot transportation trailer.

Although the description above contains many specifications, these should not be construed as limiting the scope of the invention but as merely providing illustrations of some of the presently preferred embodiments of this invention. For example, the Beverage Dispensing Box for Office and Kitchen Counters invention can have other shapes, such as rounded corners or stretched and modern body designs; can have other assembly features such as Velcro to hold the lid “cover” to the container walls; and removable parts could be made more permanent with hinges or other design features.

Thus the scope of the invention should be determined by the appended claims and their legal equivalents, rather than by the examples given.

I claim:

1. A liquid dispensing receptacle, comprising:
(a) a receptacle made from durable and sturdy material used for dispensing flexible bags of potable liquid,
(b) having an internal receptacle floor sloping toward the front of said receptacle with three stationary walls, with the left and right said stationary walls having one each retention peg hole,
(c) said three stationary walls at a height tall enough to receive (and remove) the said flexible bag of potable liquid with space between the top edge of the said three stationary walls and the top of the said flexible bag of potable liquid,
(d) a removable front receptacle panel with an opening on the said panel for the flexible bag of potable liquid fitment spigot so the said panel can be reinstalled once the said flexible bag of potable liquid and said fitment spigot are placed into said receptacle,
(e) the said three stationary receptacle walls and said removable front receptacle panel, once installed, result in equal height creating a uniform and contiguous wall surface area accepting of a receptacle lid,
(f) an off balance weighted pressure plate, heavier toward the back of the said weighted pressure plate, with a handle, can be placed inside the said uniform and contiguous wall surface area on top of the said flexible bag of potable liquid with space still available between the said weighted pressure plate and the top edge of the said uniform and contiguous wall surface area so said receptacle lid and its lid retention insert can be placed unencumbered on top of said uniform and contiguous wall surface area,
(g) said removable receptacle lid has two retention pegs, one on the left side and one on the right side of said lid retention insert, that fit into said retention holes at the top of the left and right side of said stationary receptacle walls when the said receptacle lid is placed on the said uniform and contiguous wall surface area; at the same time the said receptacle lid has a retention lip that fits over the top of the said removable front receptacle panel to keep the said removable front panel secure,
whereby said receptacle with sloped floor works in tangent with the said off balance weighted pressure plate to move the liquid in the said flexible bag to a single point using a natural, non-mechanical or electrical, pressure for dispensing the said liquid when the said spigot is opened.
